(19) United States
(12) Patent Application Publication
(10) Pub. No.: US 2019/0313231 A1
(43) Pub. Date: Oct. 10, 2019

(54) Mesh Network-Based Emergency Contact Device And System For Utilizing Such Devices

(71) Applicant: Soterra LLC, Bethlehem, PA (US)

(72) Inventors: Emily Randolph, Shamong, NJ (US); Lena Contini McDonnell, Nicasio, CA (US); John B. Ott, Belvidere, NJ (US); Christopher Justin Szafranski, Maplewood, NJ (US)

(73) Assignee: Soterra LLC, Bethlehem, PA (US)

(21) Appl. No.: 16/380,982

(22) Filed: Apr. 10, 2019

Related U.S. Application Data
(60) Provisional application No. 62/655,454, filed on Apr. 10, 2018.

(51) Int. Cl. H04W 4/90; H04W 4/80; H04W 76/11; H04W 68/00; H04W 4/02

(52) U.S. Cl. CPC H04W 4/90; H04W 4/80; H04W 4/025; H04W 68/005; H04W 76/11

(57) ABSTRACT

An emergency messaging device and related service is provided that does not rely on traditional communication network connections and may be used by individuals without means or opportunity to possess a conventional smartphone type of device. The emergency messaging device is configured as a simple, rudimentary device requiring only the capability to communicate via a short-range wireless link (e.g., Bluetooth) so as to broadcast its ID and location (using GPS data) when activated. A collection of such messaging devices that are located within range of each other form an ad hoc mesh network to relay the help message until it reaches a network-enabled communication device (such as a smartphone) that has been configured to transmit the message to a network-based emergency services platform servicing an API configured to determine and launch an appropriate response to the message.

### CROSS-REFERENCE TO RELATED APPLICATIONS

This application claims the benefit of U.S. Provisional Application No. 62/655,454, filed Apr. 10, 2018 and herein incorporated by reference.

### TECHNICAL FIELD

The present invention relates to an emergency contact device and, more particularly, to an emergency contact device that does not rely on traditional communication network connections and may be used by individuals without means or opportunity to possess a conventional smartphone type of device.

### BACKGROUND OF THE INVENTION

There are many areas around the world, as well as many diverse situations, where there is a need to reach out for emergency assistance. In many regions, people who are considered “at risk” often do not have personal access to even a rudimentary cellular device. What is needed is an extremely simple-to-operate and inexpensive communication device that neither relies on the user being accessible to a high capacity data-relaying network, nor in possession of a sophisticated processing device (such as a smart phone). However, this new device must be able to instantaneously relay precise and critical information to others. These at-risk individuals are in need of a way to protect themselves from the perpetual danger that surrounds them. While there are physical deterrents, such as pepper spray or stun guns, or more technical solutions such as smartphone apps, there is still a need for a reliable solution that can respond to an emergency situation in a timely manner in situations where other types of communication systems are not immediately available.

With the advent of sophisticated location technology, there is no shortage of communication devices particularly configured for children, pets, packages, etc., with each specific type of communication device having some special features for that particular group or purpose (including emergency service response). Indeed, the technologies may be thought of as organized along the following lines:

Communication devices that allow users to send Bluetooth, SMS, and GPS data to other users via a dynamic mesh network that is not otherwise connected to the internet. While the ability to send low power, small data content messages is useful, these communication devices do not have the ability to contact emergency services, if such is required.

Various other types of emergency communication devices (for example, a type of “panic button”) may be configured/disguised to appear as jewelry or other apparel. Many of these devices may be configured to directly communicate over a traditional telephone or internet connection with pre-defined phone numbers. One specific type of wearable device uses GSM to transmit location and medical information to emergency services (and perhaps a predetermined list of contacts). These emergency communication devices operate as stand-alone devices that interact with a conventional network and do not possess any type of short-range (e.g., Bluetooth) capability of enabling an ad hoc mesh network of a group of devices.

While all of these devices (as well as many others) are very well-suited for their particular purpose, none affords the possibility of providing emergency service to individuals that are located remotely from a traditional network and/or do not own or have access to a network-enabled communication device (or provide emergency service when a traditional communication device runs out of battery).

### SUMMARY OF THE INVENTION

The various limitations of prior art emergency communication devices are addressed by the present invention, which relates to an emergency contact device and, more particularly, to an emergency contact device and related service that does not rely on traditional communication network connections and may be used by individuals without means or opportunity to possess a conventional smartphone type of device.

In accordance with the present invention, a call-out device is configured as a simple, rudimentary device requiring only the capability to communicate via a short-range wireless link (e.g., Bluetooth) so as to broadcast its ID and location (using GPS data) when activated. The call-out device may be activated by the individual when he/she feels in imminent danger (referred to hereafter as a “red alert”). The device also has the capability to broadcast a “yellow alert” help message when the situation is not as dire, but some kind of “assistance” is needed. The yellow alert mode may also be used, for example, in situations where the user does not feel comfortable contacting emergency services.

A collection of such basic call-out devices that are located within range of each other are advantageously used to form an ad-hoc mesh network that functions to forward a broadcasted help message (i.e., device ID and GPS data) from one device to another until it reaches a network-enabled relay device (such as a smartphone) that has been configured to include an application that launches the inventive emergency service response. The network-enabled relay device (hereafter referred to as a network ERD) utilizes the downloaded app to forward the message to a network-based emergency services platform including an API configured to provide the proper emergency response. In particular, when the API recognizes a red alert help message, it is routed to the closest emergency responder (via 911, for example). Upon recognition of a yellow alert help message, the API retrieves additional user-specific information, as described below, and sends notifications of a request for assistance to the appropriate personnel.

It is an aspect of the present invention that the individual call-out devices that function as nodes in the mesh network between an initially-activated device and the network ERD function only as relay devices and require no overt actions to be taken by the individuals in possession of these other devices. Indeed, the initial message is preferably transmitted as encrypted data and remains in encrypted form as it moves from node to node in the ad hoc mesh network. The message is only decrypted once it reaches the emergency services platform.

In accordance with one or more embodiments of the present invention, upon receipt of a yellow alert messages, the emergency services platform is configured (via an API) to query an associated database to access pre-stored information associated with the registered owner of the specific call-out device that initiated a yellow alert message, and determine the proper response. In most cases, the “proper response” is for the emergency services platform to contact individuals previously defined by the registered owner as “personal contacts” (with a cellphone number listed for these persons). In this case, the identity of the person needing help, as well as their GPS data, is sent to the personal contacts, who understand how to best respond. In cases where the individual has not created a list of personal contacts, the emergency services platform treats the received message as a red alert help message and forward the request to the proper emergency responders.

In another aspect of the present invention, responding authorities may also subscribe to the inventive emergency services system to access the services platform and maintain an up-to-date status of various message alerts initiated in their areas.

An exemplary embodiment takes the form of short-range wireless emergency messaging device, comprising: (1) a short-range wireless transmission module including a processor component for storing a unique ID of the emergency message device and configured to format a data packet including the unique ID and related help information; (2) a GPS component for receiving and continually updating data defining a location of the emergency messaging device; and (3) an activation element coupled to the short-range wireless transmission module, wherein upon a user triggering the activation element, the short-range wireless transmission module broadcasts a help message data packet including the unique ID, GPS data, and a timestamp.

Another embodiment of the present invention may take the form of a system for providing emergency assistance to a population with limited access to data communications networks, where the system comprises a large number of short-range wireless emergency devices as described above, wherein the short-range wireless emergency messaging devices exchange information to form an ad hoc mesh network for relaying a help message data packet created by one of the messaging devices. The system also includes at least one network-enabled communication device within communication range of at least one messaging device, the network-enabled communication device configured to recognize the data packet format of the help message and transmit the help message to an emergency services platform configured to properly respond, based on the detailed data included in the help message.

Yet another embodiment of the present invention takes the form of a method of using a plurality of short-range wireless transmission devices to facilitate a transmission of an emergency message from one such short-range wireless transmission device to an emergency responding authority, the method comprising the steps of: (a) activating an initial transmission device to create a short-range wireless help message data packet (the data packet comprising: (1) a unique ID of the transmission device; (2) an alert level of the help message; (3) GPS data defining the location of the transmission device; and (4) a current timestamp); (b) broadcasting the help message data packet; (c) relaying the broadcasted help message data packet through an ad hoc mesh network created by the plurality of short-range wireless transmission devices until the help message data packet is received by a network-enabled external relay device (network ERD) configured to recognize the help message data packet; and (d) forwarding the help message to an API at a network-based emergency services platform particularly configured to respond to help message (including determining the appropriate responding parties based on the determined alert level).

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like elements in several views:

FIG. 1 contains a network architecture diagram of a system formed in accordance with the present invention, particularly illustrating the capability of a plurality of inventive call-out devices to create an ad hoc mesh network for relaying a help message;

FIG. 2 illustrates a set of alternative communication paths that may be established when a call-out device activates an alert;

FIG. 3 illustrates an exemplary flow of steps for responding to either a red level alert or a yellow level alert;

FIG. 4 is a flowchart summarizing the actions taken by various elements used in the emergency communication system of the present invention;

FIG. 5 is a simplified block diagram of an exemplary call-out device formed in accordance with the present invention;

FIG. 6 is an isometric view of one embodiment of the inventive call-out device;

FIG. 7 illustrates the device of FIG. 6 with the lid exposed to show the enclosed components;

FIG. 8 is an exploded view of the call-out device of FIG. 6; and

FIG. 9 shows an exemplary “dashboard” provided for use by emergency services personnel via the services communication platform of the present invention.

### DESCRIPTION OF THE INVENTION

The present invention relates to a call-out device that is rudimentary in form, but is able to be used by individuals to contact help when needed. The call-out device is not provisioned for communication via a traditional network, but instead includes a short-range wireless module (such as, for example, a Bluetooth Low Energy (BLE) or similar device) that is used to transmit a call for help. A localized group of such call-out devices creates an ad hoc mesh network, which in this case forwards the call for help in a wider and wider expanse until a network-enabled device is within range of one of the call-out devices and receives the message. The network-enabled device is configured to include an app associated with the inventive emergency services system and uses the app to relay the help message to a network platform running the emergency services API of the present invention.

A conventional smartphone that has downloaded the app associated with inventive emergency services API is contemplated as an exemplary type of network-enabled device, and is referred to hereafter as a “Network-enabled External Relay Device”, or simply “network ERD”. A network ERD in receipt of a help message will recognize the message format and directly transmit the message to the emergency services platform. The API at the platform parses the message into the proper data elements (unique ID, alert level, GPS data, and timestamp) and makes an initial determination of the alert level. If the help message is tagged as an “immediate emergency” (“red level” message), the API sends the information to a proper emergency responder (e.g., a police station closest to the GPS location of the individual).

If the received message is tagged as an “assistance requested” (“yellow level” message), the API accesses information stored in a linked database to retrieve an associated listing of personal contacts to notify. It is contemplated that a yellow level request for help would be activated by a person in situations where the need is not dire, but help would be beneficial. For example, a yellow level request could be activated when a user wants one or more people to join them in a situation where they do not want to be alone with a particular person.

As will be described in detail below, the API at the emergency services platform responds to a yellow level message by ascertaining the identity of the individual requesting help and querying an associated database to retrieve a listing of cellphone numbers associated with the individual's personal contacts. The platform then sends a notification to these contacts, including the person's identity and current location (as well as the time the original request was transmitted). The notification may take the form of a text message, voice call, or any other pre-defined messaging arrangement.

The call-out device and network of the present invention is based upon the use of GPS and short-range wireless broadcasting, such as that embodied in Bluetooth technology. It allows those without smartphones to send a signal from the device itself via a dynamic mesh network. As will be described below, the mesh network essentially employs all call-out devices in the area as network nodes, passing the help message from node to node until it reaches a network's ERD that can deliver the message to the emergency services platform.

Indeed, it is a significant aspect of the present invention that an individual call-out device does not need to be paired with a smartphone to be used and does not need to itself be connected to a conventional communication network. This is in contrast to some prior art types of “emergency assist” devices that must remain within proximity (radio range) of an associated smartphone in order to perform. Inasmuch as there are numerous situations and areas around the world where individuals lack access to smartphones, these prior art emergency assist devices are of no help. In contrast, the call-out device of the present invention is intended to eliminate the need for the individual devices to directly access a communication network and instead relay radio-based messages from one device to another (i.e., through the ad hoc mesh network) until a “local” smartphone that has downloaded the associated emergency services app is reached.

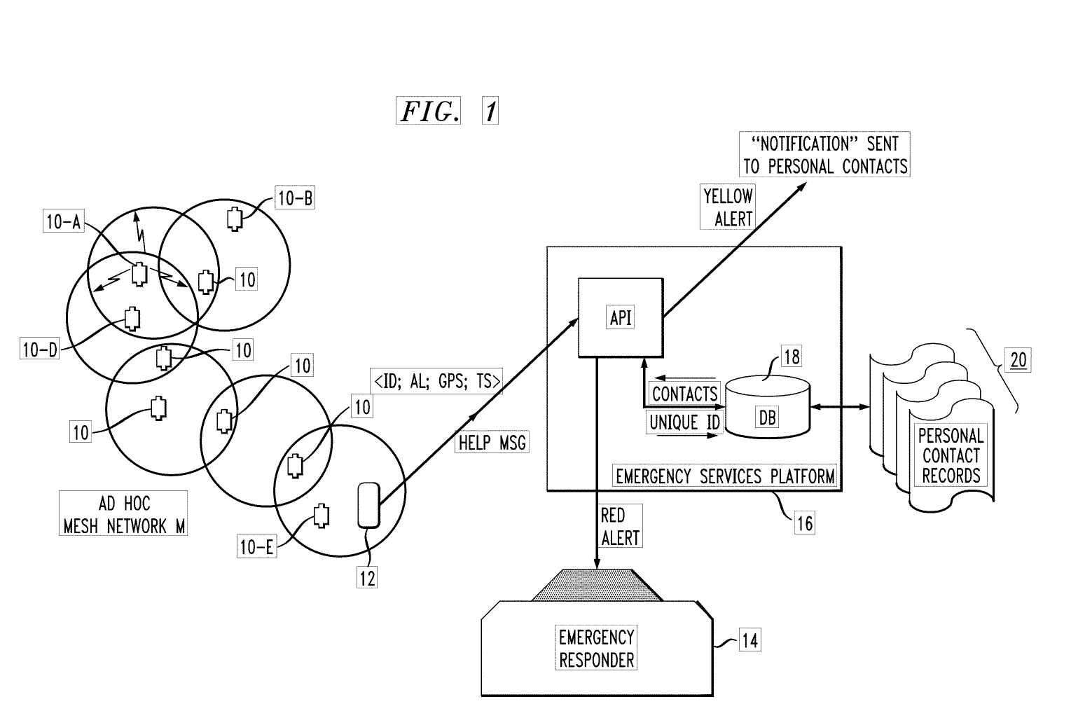

FIG. 1 illustrates this mesh network principle of providing communication in accordance with the present invention. Here, a plurality of geographically close call-out devices 10 (which will be discussed in detail below) have established communication links among themselves, creating an ad hoc mesh network M. As soon as a given call-out device is activated (for example, device 10-A of FIG. 1), it sends out a help message (in data form) that will be received by other call-out devices within its range. This may be performed, for example, by sending out a short-range wireless transmission. In particular, call-out devices 10 are equipped with a module such as a Bluetooth Low Energy (BLE) device (e.g., a device based on Bluetooth 5 specifications and utilizing Bluetooth Mesh Network) to ensure that call-out device 10 is battery efficient, exhibits long range and is reliable.

In this particular example, both devices 10-B and 10-D are within range of activated call-out device 10-A. These two devices will then re-broadcast the help message (in its original, preferably encrypted form) so as reach all other call-out devices within their ranges. The message moves through the network, reaching a device 10-E that is shown as being within the range of a network ERD 12. As mentioned above, an exemplary network ERD may be a conventional smartphone that has downloaded the emergency services app associated with the system of the present invention. It is to be noted that all of this relaying occurs automatically. There is no user input necessary at any of the intermediate call-out devices that are used as relay points/nodes in the ad hoc mesh network. All call-out devices automatically connect into the mesh network, and all network ERDs automatically act as a relay to the emergency services network platform that supports the emergency services API. This ensures no delays, and no lost signals due to the bystander effect. All of the information being sent is preferably encrypted (e.g., using RSA, which websites use for http). This ensures the user's anonymity along the network as the alert will not be decrypted until it reaches the API at the emergency services platform. Given the situations where these help messages are being transmitted, preserving the security of the user is crucial, should a malicious individual (for example) somehow come into possession of another person's call-out device, or purchase their own device to listen in on network traffic. In field trials, it is been the experience that a given message reaches the API and returns an acknowledgement signal to the user device within 90 seconds or less.

Once the help message reaches network ERD 12, the app will be activated and respond by forwarding the help message (in its encrypted form) via a conventional communication network 13 (such as the internet) to a network-based emergency services platform 16 that is running the API providing the inventive emergency services response. The API decrypts the message and parses the information to retrieve the unique ID and alert level of the message. As will be discussed in detail below, the person activating his/her call-out device 10 to broadcast a help message is able to specify the alert level to be transmitted as part of the help message. If the API at emergency services platform 16 determines that the received help message is a red level alert, it will immediately forward the message to a local emergency response agency 14. Alternatively, if the API at emergency services platform 16 determines that the received help message is a yellow level alert, it will use the retrieved unique ID to query an associated database 18 to retrieve a list of personal contacts 20 previously created by the person who initiated the help message. A notification, including the individual's name and current location, is then transmitted by platform 16 to all of the personal contacts.

Preferably, subscribers to the call-out device-based message service establish a contact list of trusted individuals (family, friends) to be contacted in response to a yellow level alert as soon as he/she receives the call-out device. However, it is possible that when the emergency services API queries the database, no listing of personal contacts for that individual is found. In that case, the emergency services platform treats the help message as a red level alert and immediately forwards the help message to the appropriate emergency responder agency.

For the creation of the listing of personal contacts, the device owner does need to have access to either a smartphone or a computer where a registration app associated with the emergency services API can be accessed. In some situations, this may be at a local community center, police station, school, or other location where people in a community may use a public smartphone or computer, thus providing the ability to create their “personal contacts”. These “personal contacts” may take the form of cell phone numbers that are owned by friends of the user. As such, these listed phones will be the receivers of a notification identifying the individual and his/her location when a yellow level alert has been sent.

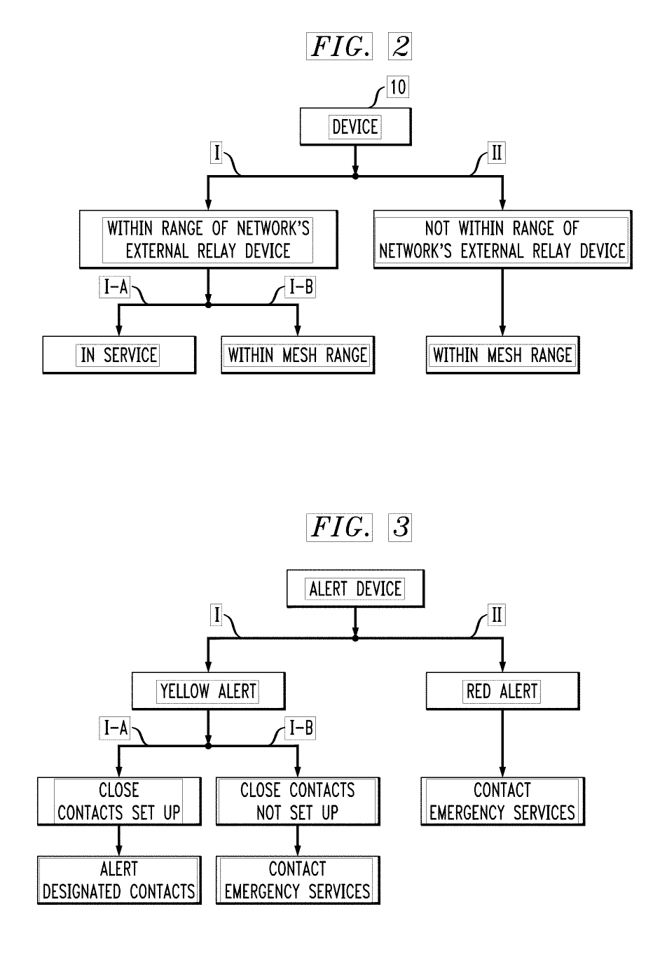

FIG. 2 illustrates an exemplary set of alternative communication paths that may be established when call-out device 10 activates an alert. In the first instance, device 10 determines if it is direct range of a network ERD (referred to as a “local ERD”, which may be a smartphone that is paired with the device—while not a likely situation, it is possible). If device 10 is within range of a local ERD, (following along branch I of the communication paths), a further determination is made to check the status of this local ERD. That is, a check is made to see if the local ERD is in communication with a local, pre-existing telecommunications network (i.e., “in service”), shown as sub-branch I-A. If the local ERD is in service, the emergency call is immediately sent out to the network. On the other hand, if the determination is that the local ERD is not connected to a network (shown as sub-branch I-B), device 10 transmits the alert to all devices within range via a mesh network protocol (see FIG. 1). Returning to branch II, if the user of device 10 is not within range of a network ERD, the alert message is immediately transmitted through the mesh network to all call-out devices within range (identical to sub-branch I-B described above) until an “in-service” network ERD is contacted.

FIG. 3 illustrates an exemplary flow of steps associated with responding to either a yellow level alert or a red level alert. As shown, an initial decision is made the user as to which level alert is to be sent. Presuming the user chooses a yellow alert, the path along branch I is followed. The next step in branch I is to determine if the user has set up a list of close contacts. This step is performed once the alert message has reached the API at emergency services platform 16, as described above in association with FIG. 1. If the listing has been created, the process continues along sub-branch I-A, and an alert message (such as a text message) is sent to the specific cell phones of the listed “close contacts”. If a listing has not been created (sub-branch I-B), the yellow alert is then necessarily treated as a red level alert and immediately sent to the proper emergency responders. It is to be noted that if this is not a response that the user desires, they may cancel the alert in the manner described below. Returning to the top of the diagram in FIG. 3, if the user selects to send a red level alert message (Branch II), the message is directly transmitted from emergency services platform 16 to the proper emergency responders.

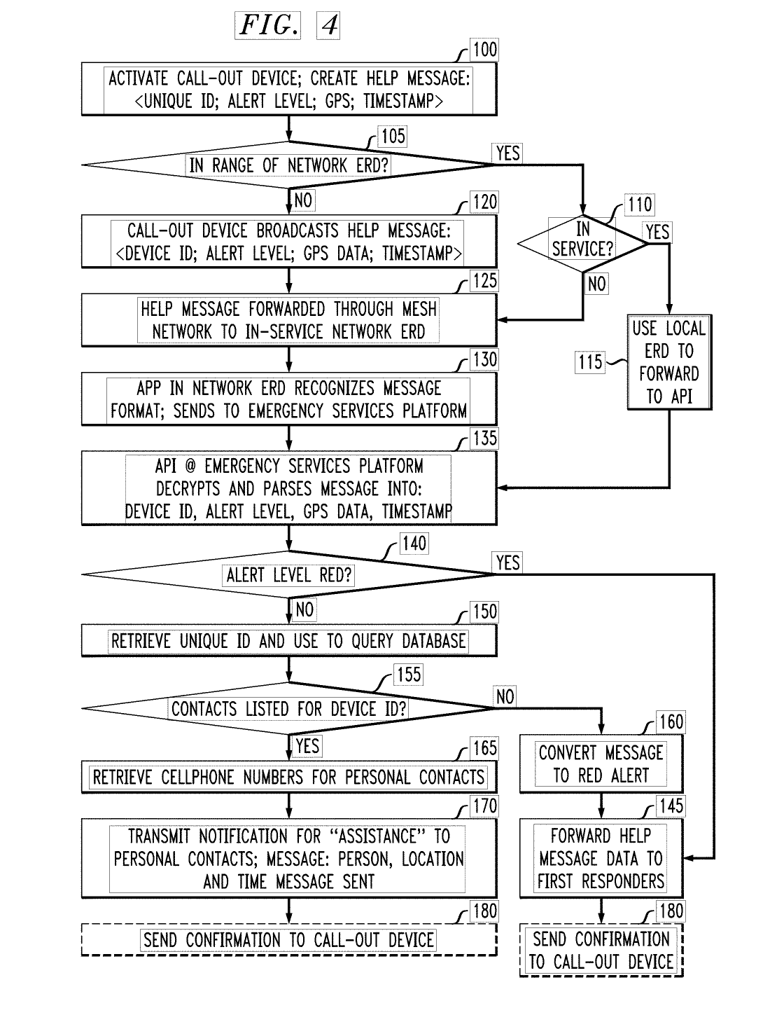

FIG. 4 is a flowchart summarizing the various actions taken by the elements involved in responding to a broadcasted help message from a call-out device of the present invention. It is to be understood that the particular sequence of steps (as well as the use of certain steps) is exemplary only, and there are various other sequences that may be used to perform emergency messaging for the call-out devices in accordance with the present invention.

The process as shown in FIG. 4 begins at step 100 with a user activating her/his call-out device. The activation process enables the enclosed short-range wireless module to transmit a data message containing the unique ID of the user and the selected alert level, as well as the GPS data of the device's current location and the time that the call-out device was activated. Following activation, a determination is made to see if there is a network ERD within the immediate range of the initiating call-out device (step 105), which as mentioned above may be a paired smartphone. If there is such a network ERD (also referred to above as a “local ERD”), a check is made to see if this ERD is in service (step 110). If the local ERD is indeed in communication with a network and has downloaded the app necessary to implement the emergency services function of the present invention, that local ERD will immediately transmit the help message to the network platform implementing the associated API (step 115) to initiate the process of obtaining help for the individual (as will be described below, beginning with step 135).

If, however, the local ERD is not in service, or if the activating call-out device is not within range of a network ERD (the latter illustrated as the “no” result from step 105), the process continues with the activated call-out device broadcasting its help message (step 120) to be received by all other call-out devices within its transmission range. (Note: in another exemplary sequence, the process may move from step 100 direction to step 120). As discussed in detail above, the ad hoc mesh network created by various call-out devices in a local area will continue to relay the help message until it reaches a network ERD that is in service and in communication with the emergency services platform (step 125). At this point in the process flow, the network ERD (which has downloaded the associated app) recognizes the format of the help message (step 130) and transmits the message directly to a network-based emergency services platform that is running the emergency services API of the present invention. (step 130).

The API functions at step 135 to decrypt (if necessary) the received message and retrieve the individual data elements (unique ID, alert level, GPS information, timestamp). Next, the API determines if the received help message is a red level alert (step 140). If it is, the API at the emergency services platform immediately forwards the data content of the message to the proper local emergency responders (step 145). The retrieved GPS information is typically used to determine the proper entity to be contacted. Returning to step 140, if the result of the query is that the help message is a yellow level alert (i.e., the response to the query is “no”), the API uses the unique ID included in the message to query a linked databased to see if the associated individual has established a list of personal contacts to be messaged under these circumstances (step 150). If no listing is found (step 155), the API re-labels the message as a red level alert (step 160), where it then follows the path as outlined in step 145.

On the other hand, if the database query performed at step 155 is successful, a listing of personal contacts for the individual is retrieved (step 165). The API then sends out a notification message (step 170) to the cellphone numbers found in this listing. The notification includes at least the name of the person requesting help and their physical location. If the cellphone number is associated with a smartphone, a link to a map showing the person's location may also be transmitted.

While not required, the flowchart of FIG. 4 shows the further transmission of a confirmation message to the individual that initiated the call for help, for both the red level alert response and yellow level alert response, shown as step 180 in FIG. 4. As described below, this confirmation may be implemented as a feedback element in the form of a vibrating motor included within call-out device 10, so that the user receives the confirmation in terms of a gentle vibration that will not be noticed by other. Other types of feedback devices may be used for this purpose, including the receipt of a particular audio tone, or the illumination of a particular LED (or set of LEDs). user will be aware of the response. Indeed, it is possible to utilize different patterns of responses from the feedback element to let the individual know who will be responding (i.e., the police or a personal friend).

The call-out device and emergency services platform of the present invention uses GPS information to accurately determine where the user is, as well as how fast (and in what direction) the user is moving (if indeed the user is not stationary). As long as the call-out device is in an active “alert” mode (i.e., the user has initiated an alert), the user's location will be continuously sent to the API at the emergency services platform and relayed to the responding personnel. This means that emergency responders know where a specific user was, is, and will be, even if their immediate location is constantly changing. It has been found that the call-out device's GPS position readings are accurate to within a 2.5-meter circle of the user, and its velocity readings are accurate to within 0.1 m/sec. These results are significantly more accurate than attempting to locate a mobile phone call to emergency phone responders, which relies on cell tower triangulation and is typically off by an average of 125 meters. The difference between the 2.5 meters with the inventive call-out device and 125 meters with a standard smartphone speaks for itself when attempting to locate an individual in trouble.

With this understanding of the networking aspects of the emergency services system of the present invention, details of an exemplary call-out device 10 will now be described.

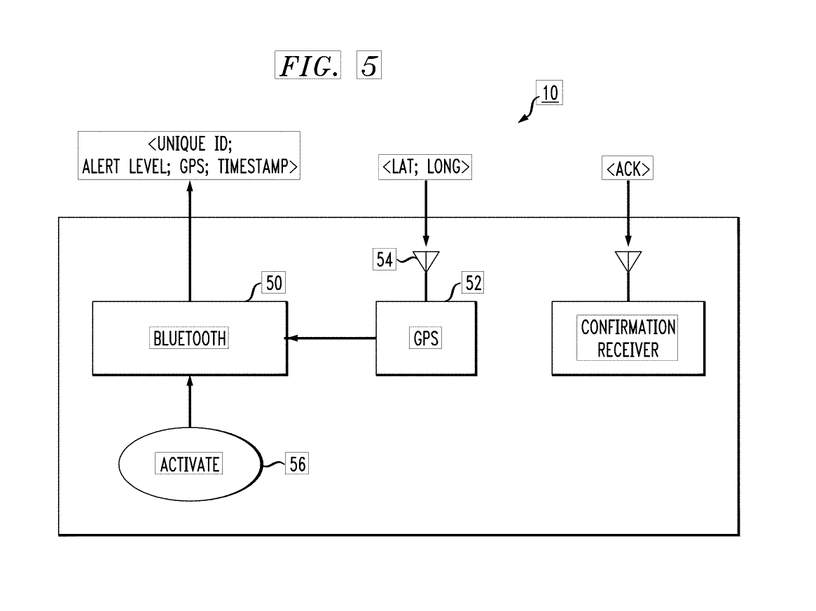

FIG. 5 is a simplified block diagram of an exemplary call-out device 10 formed in accordance with the present invention. As shown, call-out device 10 includes a short-range transmission module 50 (such as a Bluetooth Low Energy module, described above) used to broadcast a call for help. Call-out device 10 also includes a GPS unit 52 that functions in a well-known manner to maintain current geographical information defining the location of call-out device 10 via an embedded antenna 54. An activation switch 56 is used to energize BLE module 50 when an individual desires to transmit a call for help. As will be discussed below, various configurations of activation switch 56 may be employed to associate the proper alert level with the transmitted message. For example, when activation switch 56 takes the form of a button, the user may press the button a different of times for the different alert levels. Alternatively, a pair of individual switch mechanisms may be included, one for each alert level.

When energized, BLE module 50 formats a data package containing the unique ID associated with call-out device 10, the current GPS data and a timestamp (also from GPS 52) and the alert level (yellow or red) entered by the user. The data package is then transmitted as a short-range wireless message in the manner discussed above.

In preferred embodiments of the present invention, call-out device 10 further includes a component that is configured to receive a return message from the emergency services platform, confirming that their message has been received and help is on the way. The diagram of FIG. 5 includes an alert confirmation component 58.

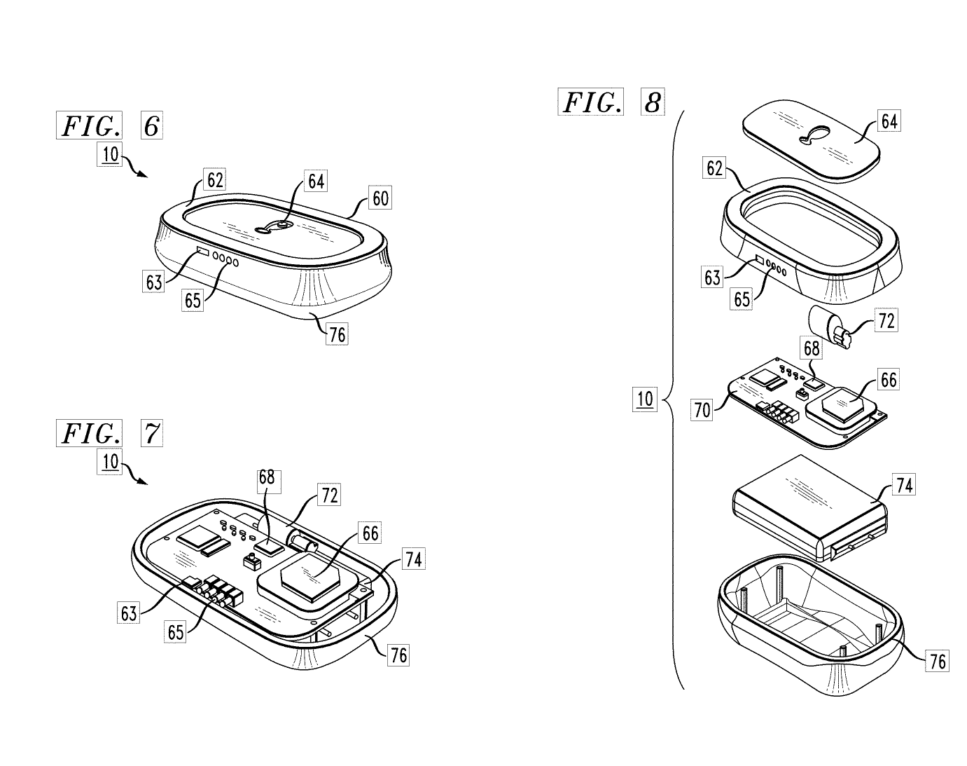

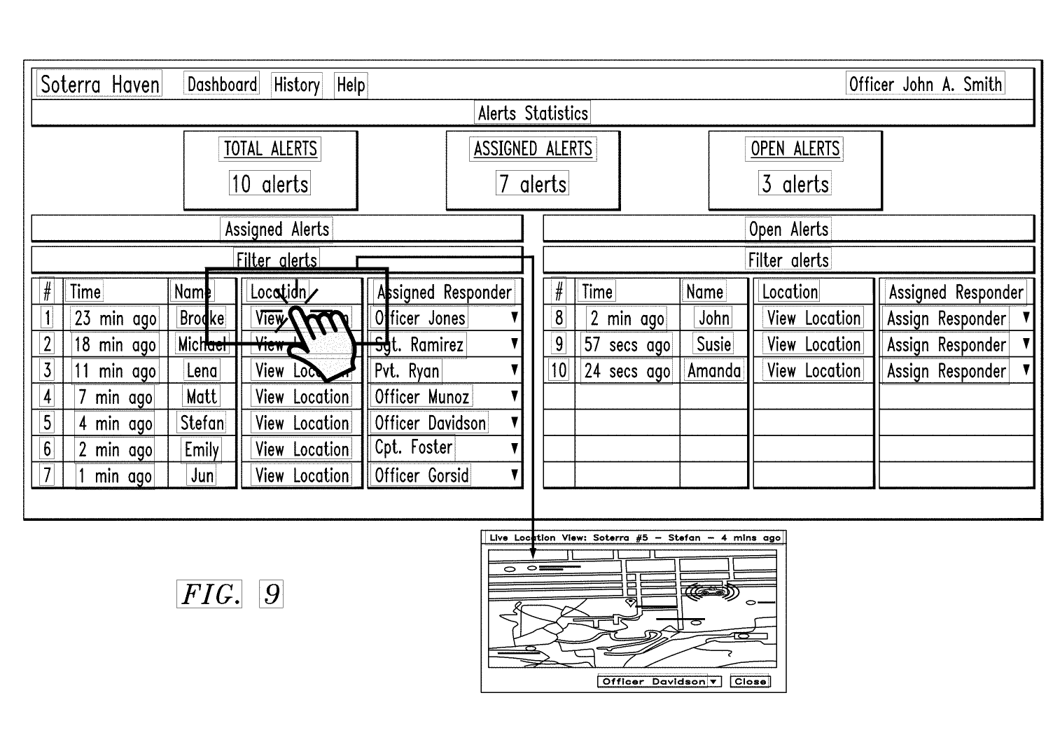

FIG. 6 is an isometric view of an exemplary configuration of call-out device 10 formed in accordance with the present invention, and FIG. 7 is a similar view of the same device 10, in this case with its lid component 60 removed. FIG. 8 is an exploded view of device 10, illustrating in particular the various components forming the device as discussed above in association with FIG. 5.

Call-out device 10 of the present invention is intended to be relatively small in size (for example, smaller than a smartphone) so that it may be carried surreptitiously should the need arise. Referring to FIG. 8 in particular, lid component 60 is shown as including a collar element 62 that includes a port 64 for a USB-Micro connector (or other suitable type of connector), as well as ports 65 for light indicators. In this particular configuration of a call-out device formed in accordance with the present invention, a large button 64 is disposed within a central opening of collar element 62. Button 64 functions as activation switch 56, discussed above in association with FIG. 5. Button 64 is preferably textured in a distinctive manner so that a user need not be looking at the device when the need arises to send out a call for help.

With continuing reference to call-out device 10 as shown in FIG. 6, the two different alert levels may be generated by controlling the number of times activation button 64 is pressed. For example, activation button 64 may be depressed twice to activate a yellow level alert, with a set of three pushes of activation button 64 associated with the transmission of an emergency red level alert help message. As mentioned above, is to be understood that the use of a single activation button in this manner is only one exemplary embodiment. In an alternative configuration, an exemplary call-out device 10 may be configured to include a pair of separate activation buttons (of different locations, colors, sizes, textures, etc.), with a first button used to broadcast a yellow alert help message and a second button used to broadcast a red alert help message.

Preferably, call-out device 10 is configured to include a means for the individual to “cancel” a help message that has already been broadcasted. For example, activation button 64 may be depressed and held down for several seconds to transmit an “ignore” message. Or a separate element may be formed on the surface of call-out device 10 and used to cancel a pending call for help.

Also shown in the views of FIGS. 7 and 8 is a short-range wireless transmission module 66 (such as, for example, a Bluetooth Low Energy device) and a GPS unit 68. A printed circuit board (PCB) 70 is used to support these various devices, as well as provide the electrical signal paths to/from/between the elements.

As mentioned above in association with FIG. 5, a preferred embodiment of call-out device 10 further includes an alert confirmation component 58 that provides some type of indication to the user that the transmitted message has indeed been received at the emergency services platform and “help is on the way”. With reference to FIGS. 7 and 8, an exemplary embodiment of confirmation component 58 is shown as comprising a vibrating motor 72 that is positioned adjacent to (and energized via) PCB 70. Thus, with this particular embodiment, the user will be able to feel the vibration of device 10 and be assured that help is on the way. It is also contemplated that a different vibration pattern may be sent as a confirmation to the user depending on who has been contacted. For example, a series of short vibrations may be used to indicate that “close contacts” have received the alert versus the use of a single, long vibration to indicate that emergency services will be responding. This way, the user will know which path the message is following and with this information the user can decide if they want to continue with the call-out for help.

Other embodiments of alert confirmation component 58 may comprise an indicator lamp (e.g., a “green” light), including the transmission of a series of pulses to cause the indicator lamps to blink. FIGS. 7 and 8 also shows an exemplary battery 74 that is used to energize device 10. A bottom support base 76 engages with lid component 60 to form the complete device.

In preferred configurations, call-out device 10 is both water resistant and shock resistant. Besides the basic necessary components described above, other embodiments of call-out device 10 may include additional elements useful to collect and transmit additional information to the emergency services platform. For example, call-out device 10 may be further configured to include a barometric sensor (not shown). With this additional element, if a call for help is transmitted from a multi-floor building, the responders will be able to pinpoint the vertical location of the caller. In particular, the passive barometer is used to perform pressure readings, which are then transmitted with the remainder of the data packet when an alert is initiated. Once this data reaches the system's API at emergency services platform 16, the interface will use the local weather data to accurately pinpoint the user's altitude.

In accordance with other aspects of the present invention, the API at emergency services platform 16 is preferably configured as a web-based interface that sends real-time information of the victim to emergency responders. Importantly, emergency response organization may subscribe to the emergency services system, so as to have direct access to emergency services platform 16 and then use the API to accurately determine the latitude and longitude of the victim through GPS, as well as the altitude or floor associated with the victim's location.

Additionally, emergency services platform 16 is configured to work with coordinated response teams. Each individual team is then able to log in and access the API at platform 16 to manage alerts. Operators can assign alerts to certain responders. For example, an operator at a local police station can assign an officer to respond to a specific alert. FIG. 9 illustrates an exemplary dashboard page associated with capability. On this page, responders can quickly view all active alerts via the layout. If responders want to get a closer look at a specific alert, they can click on “View Location” and, as shown, an associated real-time map of that user's location will be provided.

Summarizing, using a rudimentary communication device operating at a locally-appropriate radio frequency (e.g., Bluetooth, as discussed above), the present invention provides a versatile ad hoc network capability that continually connects an ever-changing group of individuals (who may have no other means of communication) to emergency support systems, even in locations previously unreachable or with poor quality connectivity. Each device is interconnected with those around it to form a mesh network, thus allowing individuals in need (regardless of their connectivity resources), to alert and seek help from a support system.

It will be appreciated by persons skilled in the art that the present invention is not limited to what has been particularly shown and described hereinabove. Although the present invention has been described in its preferred forms with a degree of particularity, it is understood that the present disclosure of the preferred forms has been made only by way of example and that numerous changes in the details of construction and the combination and arrangement of the parts may be made without departing the scope of the present invention.

What is claimed is:

1. A short-range wireless emergency messaging device, comprising
a short-range wireless transmission module including a processor component for storing a unique ID of the emergency message device and configured to format a data packet including the unique ID and related help information;
a GPS component for receiving and continually updating data defining a location of the emergency messaging device, the GPS component in communication with the short-range wireless transmission module; and
an activation element coupled to the short-range wireless transmission module, wherein upon a user triggering the activation element short-range wireless transmission module broadcasts a help message data packet include the unique ID, GPS data, and a timestamp.

2. The short-range wireless emergency messaging device as defined in claim 1 wherein
the processor component is further configured to recognize at least two different signals received from the activation element, the at least two different signals associated with different levels of emergency, with the help message data packet further including information associated with received alert level.

3. The short-range wireless emergency messaging device as defined in claim 2 wherein the activation element is configured to transmit a first alert signal associated with a need for immediate emergency help and a second alert signal associated with a request for assistance from a predetermined set of personal contacts.

4. The short-range wireless emergency messaging device as defined in claim 4 wherein the activation element comprises an activation button, with a first number of button presses associated with the first alert signal and a second number of button presses associated with the second alert signal.

5. The short-range wireless emergency messaging device as defined in claim 1 wherein the emergency messaging device further comprises
a confirmation component for receiving a return message acknowledging the receipt of the help message by an appropriate responder.

6. The short-range wireless emergency messaging device as defined in claim 5 wherein the confirmation component comprises a feedback element that is energized when a return message is received.

7. The short-range wireless emergency messaging device as defined in claim 6 wherein the feedback element is selected from the group consisting of: an audio speaker, a vibrating motor, and at least one LED.

8. The short-range wireless emergency messaging device as defined in claim 1 wherein the device further comprises a passive barometer element for monitoring a local barometric level and transmitting a current barometric reading to the processing component during the creation of the data packet for appending the barometric level to the broadcasted help message.

9. A system for providing emergency assistance to a population with limited access to data communications networks, the system comprising
a plurality of short-range wireless emergency messaging devices, each device comprising
a short-range wireless transmission module including a processor component for storing a unique ID of the emergency message device and configured to format a data packet including the unique ID and related help information;
a GPS component for receiving and continually updating data defining a location of the emergency messaging device, the GPS component in communication with the short-range wireless transmission module; and
an activation element coupled to the short-range wireless transmission module, wherein upon a user triggering the activation element short-range wireless transmission module broadcasts a help message data packet include the unique ID, GPS data, and a timestamp,
wherein the plurality of short-range wireless emergency messaging devices exchange information to form an ad hoc mesh network for relaying a help message data packet created by one of the plurality of messaging devices; and
at least one network-enabled communication device within communication range of at least one messaging device, the network-enabled communication device configured to recognize the data packet format of the help message and transmit the help message to an associated network-based emergency services platform implementing an emergency services API.

10. The system as defined in claim 9 wherein at least one short-range wireless emergency message device is configured to broadcast a first help message including a first alert signal associated with a need for immediate emergency help and a second help message including a second alert signal associated with a request for assistance from a predetermined set of personal contacts.

11. The system as defined in claim 9 wherein the API implemented at the network-based emergency services platform is configured to recognize both the first alert signal and the second alert signal, immediately forwarding messages with the first alert signal to emergency responders and determining personal contacts for messages with the second alert signal.

12. The system as defined in claim 11 wherein the API implemented at the emergency services platform is configured to determine personal contacts by:
retrieving the unique ID from the received messaging signal,
retrieving a list of personal contact cellphone numbers associated with the unique ID, and
sending an assistance notification to the personal contact cellphone numbers, the assistance notification including at least a person's name and GPS information.

13. The system as defined in claim 7 wherein the API implemented at the emergency services platform is further configured to send an acknowledgement message back to the short-range wireless transmission device that was activated.

14. A method of using a plurality of short-range wireless transmission devices to facilitate a transmission of an emergency message from one such short-range wireless transmission device to an emergency responding authority, the method comprising the steps of:
activating an initial transmission device to create a short-range wireless help message data packet comprising: (1) a unique ID of the transmission device; (2) an alert level of the help message; (3) GPS data defining the location of the transmission device; and (4) a current timestamp;
broadcasting the help message data packet;
relaying the broadcasted help message data packet through an ad hoc mesh network created by the plurality of short-range wireless transmission devices until the help message data packet is received by a network-enabled external relay device (network ERD) configured to recognize the help message format; and
forwarding, by the network ERD, the recognized help message to a network-based emergency services platform implementing an API for determining an appropriate response to the help message based on the determined alert level.

15. The method as defined in claim 14 wherein the alert level comprises a pair of different alert levels, a first alert level associated with an immediate emergency and a need for emergency responders and a second alert level associated with a request from assistance from a predetermined list of personal contacts.

16. The method as defined in claim 13, wherein the API at the emergency services platform forwards a help message including the first alert level to local emergency responders based on retrieved GPS information.

17. The method as defined in claim 15, wherein if the API at the emergency services platform determines that the help message includes the second alert level, the method further includes the steps of:
retrieving the unique ID from the received help message;
querying a local database to retrieve a list of personal contact cellphone numbers associated with the unique ID, where if the query returns a null response, the API forwards the help message to local emergency responders, otherwise;
sending an assistance notification to the personal contact cellphone numbers associated with the unique ID, the assistance message including at least a person's name and GPS information.

18. The method as defined in claim 17 wherein the assistance notification comprises a text message.

19. The method as defined in claim 18 wherein the text message further includes, when available, a hot link to a map of the GPS data.

20. The method as defined in claim 14, wherein the method further comprises the step of transmitting an acknowledgement confirming receipt of the help message from the API to the initial transmission device.
